(19) United States
(12) Patent Application Publication
(10) Pub. No.: US 2003/0096598 A1
(43) Pub. Date: May 22, 2003

(54) Method for transmitting data

(76) Inventors: Ralf Prenzel, Salzgitter (DE); Christoph Wojzischke, Braunschweig (DE); Markus Trauberg, Velchede (DE)

Correspondence Address: Bell, Boyd & Lloyd, LLC, P.O. Box 1135, Chicago, IL, 60602, US

(21) Appl. No.: 10/157,456

(22) Filed: May 28, 2002

(30) Foreign Application Priority Data
May 28, 2001 (DE) 101 25 892.5
Oct. 11, 2001 (DE) 101 50 130.7

(51) Int. Cl. H04Q 7/20

(52) U.S. Cl. 455/412; 455/557; 455/466

(57) ABSTRACT

A method, a subscriber terminal, a computer program product and a communications system are proposed via which an initially displayed image of data is preset essentially freely for a receiver, and an element is tagged in order to allow this element to be displayed as soon as the data is opened.

### BACKGROUND OF THE INVENTION

The present invention relates to a method for transmitting data, to a subscriber terminal, to a computer program product and to a communications system. For purposes of the present invention, the term data also refers to any type of information which is assembled from individual components. In this case, these individual components or elements may be formed based on different standards. Accordingly, a multimedia message may also represent data for this purpose.

Methods and apparatuses for transmission of different forms or formats of data are known. A mobile radio system based on the Global System for Mobile Communications Standard, GSM for short, offers, for example, not only speech telephony but also the capability to send and to receive short messages with a length of up to 160 characters. This service is referred to as the short message service (SMS).

For the next generation mobile radio system, the Universal Mobile Telecommunications System (UMTS), a multimedia variant of a mobile message service, is currently being standardized, the so-called Multimedia Messaging Service MMS, see 3GPP TS 23. 140 version 4. 1. 0, Release 4; Third Generation Partnership Project; Technical Specification Group Terminals; Multimedia Messaging Service (MMS); Functional Description; Stage 2 and 3GPP TS 22. 140 v. 4. 0. 1 (July 2000), 3rd Generation Partnership Project; Technical Specification Group Services and System Aspects; Service Aspects; Stage 1 Multimedia Messaging Service. Information in the form of messages with multimedia contents is referred to in the following text only as a multimedia message, or MM for short, in order to provide a better distinction between them and SMS text messages. In contrast to SMS, MMS has no restriction to pure text contents. Using the MMS, it is also possible to format texts as appropriate for the individual's taste, and to embed any desired contents in a message. This includes, for example, audio and video contents, still pictures, graphics, texts, etc.

According to the previous prior art, MMS can be implemented only using the Wireless Application Protocol WAP. The use of the WAP Wireless Session Protocol WSP is intended to bridge the air interface between an MMS-compatible terminal and the WAP gateway, WAP-209-MMS Encapsulation, Release 2000; Wireless Application Protocol; WAP Multimedia Messaging Service; Message Encapsulation; MMS Proposed SCD 1.0 and WAP-203-WSP, Version May04, 2000; Wireless Application Protocol, Wireless Session Protocol Specification; Chapter 8. 4: “Header Encoding”.

A further widely used system is the Internet e-mail, see RFC822: “Standard for the Format of ARPA Internet Text Messages”, Crocker D. , August 1982. URL: ftp://ftp.isi.edu/in-notes/rfc822.txt. Nowadays, an e-mail may be used to transport virtually any desired contents without any size restrictions, so that the Internet e-mail now, in principle, offers similar functions to MMS. However, until now, it has been used virtually exclusively for landline-linked terminals. In contrast to MMS, Internet mail fundamentally includes header elements and text. Further objects, including multimedia objects, can be optionally integrated in Internet mail using the Multipart Internet Mail Extension MIME, RFC2045: “Multipurpose Internet Mail Extensions (MIME) Part One: Format of Internet Message Bodies”, Freed N., November 1996, URL: ftp://ftp.isi.edu/in-notes/rfc2045.text..; RFC2046: “Multipurpose Internet Mail Extensions (MIME) Part Two: Media Types”, Freed N., November 1996. URL: ftp://ftp.isi.edu/in-notes/rfc2046.txt; RFC2047: “MIME (Multipurpose Internet Mail Extensions) Part Three: Message Header Extensions for Non-ASCII Text”, Moore K., 11. 1996. URL:ftp://ftp.isi.edu/innotes/rfc2047.txt.

Since the Internet e-mail originates from a short written message, the user of such an e-mail is also used to a situation in which the text contained directly in the header of the mail is displayed to him/her first of all, after a mail item has been opened, in his/her Internet Mail User Agent MUA, the program for receiving, sending and processing the mail items. It is normal to cross-refer therein to the objects attached to the mail item and, if necessary, to relate them to the context of the text.

The present invention is directed toward a method, a subscriber terminal, a computer program product and a communications system via which the receiver can essentially freely preset an initial displayed image.

### SUMMARY OF THE INVENTION

The method according to the present invention is accordingly distinguished by an element being tagged in order to allow this element to be displayed on the receiver as soon as the data is opened. A predetermined element based on any desired standard is thus opened automatically from a data set to be transmitted, so that the receiver is no longer necessarily displayed a text; this being in contrast, for example, to an e-mail. The immediately opened element also may use audio contents, depending on the choice made by a sender, in order to make the receiver individually aware of a newly received multimedia message.

In an embodiment of the present invention, the data is preprocessed for dispatch such that it has a header for transporting organization information and a body for transporting respective payload information. The payload information in this case preferably includes elements in the form of a number of data packets. In this case, the method according to the present invention is preferably used for data which is transmitted as a Multimedia Message MM in a Multimedia Message Service MMS; in particular, to a mobile subscriber terminal or, especially, to a WAP-compatible mobile telephone.

At the moment, the MMS has no capability to describe to the receiving User Agent information for the receiver using the initial MM displayed image. According to the present invention, all that is provided here now is the capability to cross-reference to an element contained in the MM, and hence for a sender to specify precisely the initial display of the MM for a receiver. In addition to displaying a text, it is also possible to define any form of multimedia presentation, for example an audio sequence, a still picture, or else a video sequence as an introduction which starts running immediately.

The coding of a so-called start parameter at the start of the data part of an MM in the MMS is admittedly known from the prior art, with the start parameter cross-referring to the MM element which contains a presentation description. The Synchronized Multimedia Integration Language SMIL, see SMIL 2. 0 Specification; W3C Working Draft of Jan. 3, 2001; http://www.w3.org/TR/smil20/ should be referred to at this point, as an example of a presentation description. A presentation description such as this makes it possible to define the way in which the elements contained in the MM will be displayed. However, firstly, there is no stipulation that the presentation description should be evaluated immediately after opening of the MM so that the presentation also starts immediately and, secondly, the specification does not cover the support of a presentation description format within the standards for an MMS User Agent for the purpose of defining the initially displayed image of the MM. Thus, if an MM had a presentation description object and the receiving MMS User Agent had the capability to play this, there still would be no information on how to activate this presentation description, and to play the presentation, immediately after opening the MM.

According to the present invention and in compliance with one standard, a capability is provided for tagging an object of the data part in an MM in the Multimedia Messaging Service MMS, for display by the receiving User Agent, with the aim being to display and play the object to the receiver, by the receiving User Agent, as soon as the MM is opened. For this purpose, one embodiment of the present invention proposes that the appropriate information in the MM be coded. The information relating to which element of the MM is intended to be displayed can, however, according to the present invention, be coded in three ways:

1. A data element (Header Field) is inserted in a header of the MM which cross-references, for each unique identifier (identification; for example: Content ID) to that element of the data part which is to be output first of all, and as soon as the MM is opened. The annotated element must be given a unique identification for this purpose, in the data part itself.

2. If the header of an MM already contains the descriptions which are uniquely associated with the elements of the MM, the desired information can be coded using a marking; for example, in the form of a flag within the description of the element of the MM which is intended to be displayed immediately on opening.

Methods for setting up, for example, a content ID or uniquely associated description with a flag based on the two items mentioned above have been disclosed by the applicant in the European Patent Applications with the application numbers EP01 101 057. 6 and EP 01 107 278. 2.

3. Furthermore, that element of the MM which is intended to be output first of all and immediately, can be identified in a data part of the MM by a marking in the form of flag in the header fields of the element itself.

Coding can be carried out in the form of coding of the field name and/or coding of the field value. In one embodiment of the present invention, the header field in WAP is coded in accordance with case 1. In this case, the coding is carried out as coding of a field name and of a field value. The field name with the new designation X-Mms Initial Presentation Content ID is, in one embodiment of the present invention, in the form of a hexadecimal number 0x1F, as shown in FIG. 6, and the field value of X-Mms Initial Presentation Content ID is in the form of a text string, as shown in FIG. 2. In this case, the information in the header of the MM is preferably coded using the header field X-Mms Initial Presentation Content ID, and the element to be identified is assigned a content ID in a data part of the data to be transmitted, or of the MM.

As an alternative, according to case 3, an additional header field in WAP is coded as follows based on a field name and a field value: coding of the field name X-Mms Initial Presentation Flag as 0x20 as shown in FIG. 6, coding of the field value of X-Mms Initial Presentation Flag as shown in FIG. 3. In this case, a header field X-Mms Initial Presentation Flag is preferably added to an element to be identified in a data part of the MM. Furthermore, the element is marked in a data part of the data to be transmitted in the MM.

In one particularly preferred embodiment of the present invention, according to case 2, an element to be identified is assigned a content ID in a data part of the MM. A cross-reference to the content ID is inserted in a header of the relevant MM, via which, according to [11], a description of the element of the MM can be inserted. Within this description, the element of the MM can be marked with an initial Presentation Flag parameter, as shown in FIG. 4.

The respective advantages of the three cited options will be described in detail of the following text with reference to an exemplary embodiment.

The tagging based on one or more of the abovementioned features is, in one embodiment of the present invention, coded in the data of the MM which is sent from a sending MMS User Agent to an MMS Relay for sending the MM. According to the WAP standard, the coding is thus carried out in the M-Send. req message. The coding is carried out centrally in the transmitter, so that there is no longer any need to modify the data subsequently in a transmission chain, which is still to be described, with reference to a figure in the drawing.

In one alternative method, the tag can be coded in the data which is transmitted from an MMS Relay to a receiving MMS User Agent in order to notify the receiving User Agent that new data (MM) is present. According to the WAP standard, this corresponds to coding in the M-Notification. ind message. Finally, the tag also can be coded in the data which is sent from an MMS Relay to a receiving MMS User Agent for delivery of the MM. According to the WAP standard, this corresponds to the M-Retrieve. conf message. In this case, these two coding methods have the common feature that tasks are moved from the transmitter to the communications system. Intelligence is thus introduced into the network, so that processing can be carried out more quickly and, furthermore, new methods or method elements can be used in the transmitter even without any retrofitting, since a new method now replaces an old method, centrally. Not least, it is important that the transmitter's resources are conserved by reducing the load on it. This relates, in particular, to the batteries or rechargeable batteries which, as a result of this measure, need to provide less energy for processing. Furthermore, when data is dispatched, it is also possible to use compression methods to speed the process up and to further reduce the load on the power supply as well.

In one advantageous embodiment of the present invention, a tagged element is transmitted in a preferred manner to the receiving User Agent. Thus, in one preferred embodiment, a predetermined information item is actually in the data element to be opened initially and can be used as a decision aid to determine whether the tagged element is intended to be transmitted in a preferred manner or on its own to the User Agent. Furthermore, this allows a receiver to make a better decision as to how the relevant MM, after receiving a tagged element for initial starting of the MM, should be transmitted and whether all further elements should be received or rejected. Feedback relating to this decision also can be, passed to the transmitter, as in [11]. This method also can be used in a general form for dispatch of data or messages with an informative or commercial content in a communications system according to the present invention. In contrast to known advertising and information methods, it offers the major advantage that it may be preprocessed only electronically and not be produced as a physical entity. This thus avoids production costs and storage, as well as significant distribution costs. In this case, marketing can be fully automated and, furthermore, different additional forms of the resonance of the involved traffic groups which are addressed directly also can be evaluated. The numbers of downloads partially or completely carried out can be evaluated as a measure of the acceptance of an advertising measure. At the moment, the effectiveness of an advertising measure can be measured only from orders, or in the worst case on the basis of complaints.

The additional information in a receiver notification M-Nind is, in one preferred embodiment of the present invention, also used in the extended form by a receiver in order to deliberately download only the marked element of the MM, as is made possible on the basis of the patent applications cited above.

According to one of the above features, one element can be marked such that it is also opened and displayed first of all among a number of identical elements. In one preferred embodiment of the present invention, audio contents or even video contents are selected as the first element to be opened. The sender can thus individually configure the start of his/her MM in the receiver.

Additional features and advantages of the present invention are described in, and will be apparent from, the following Detailed Description of the Invention and the Figures.

### BRIEF DESCRIPTION OF THE FIGURES

FIG. 1 shows a schematic illustration of transmissions associated with data transmissions based on the Wireless Application Protocol or WAP standard, between the sender level or the provider level at one end, and the provider level or the receiver level at the other end.

FIG. 2 shows coding of the new header field based on the 1st case according to the present invention.

FIG. 3 shows coding of the new header field name based on the 3rd case according to the present invention.

FIG. 4 shows coding of the parameter names and parameter values in tabular form, with entries that are newly introduced on the basis of the 2nd case of the present invention being shown on a gray background, and with all the other parameters originating from [11].

FIG. 5 shows coding of the header field according to the present invention.

FIG. 6 shows an illustration of the assignment of binary codes to the field names, with new entries introduced on the basis of the present invention in comparison to [2] 7. 3 being shown on a gray background.

FIG. 7 shows a tabular illustration of the header fields of the M-Send. req WAP transmission request message, with new entries introduced on the basis of the present invention in comparison to [2] 6. 1 being shown on a gray background, and with all the other parameters originating from [2] 6. 1.

FIG. 8 shows a tabular illustration of the header fields of the M-Notification. ind WAP message in accordance with [2] 6. 2.

FIG. 9 shows the header fields in the M-Retrieve. conf WAP message in accordance with [2] 6. 3.

### DETAILED DESCRIPTION OF THE INVENTION

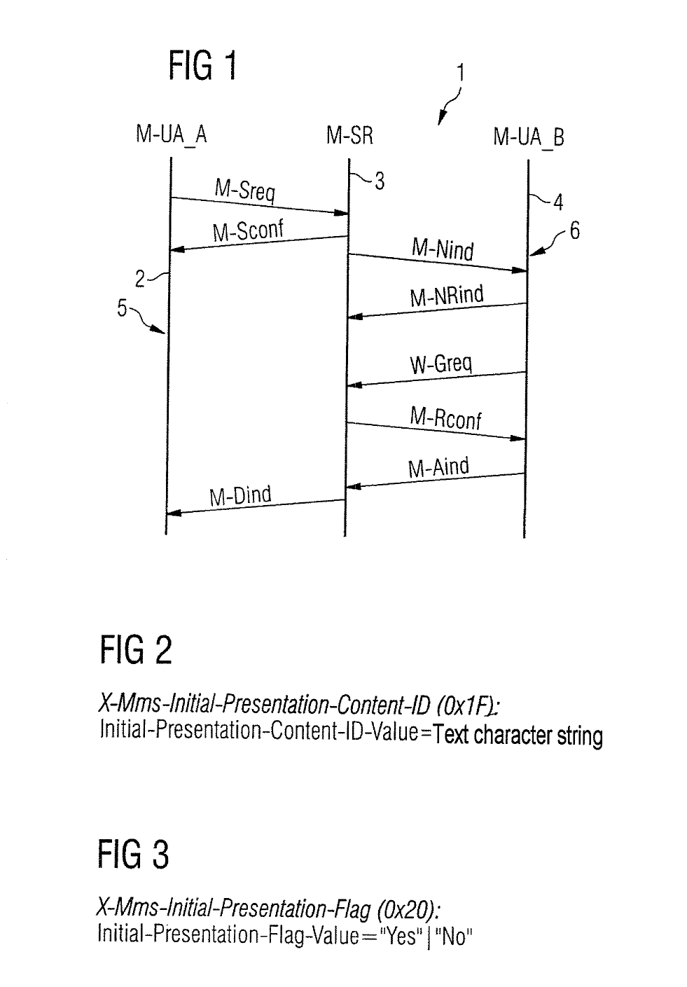

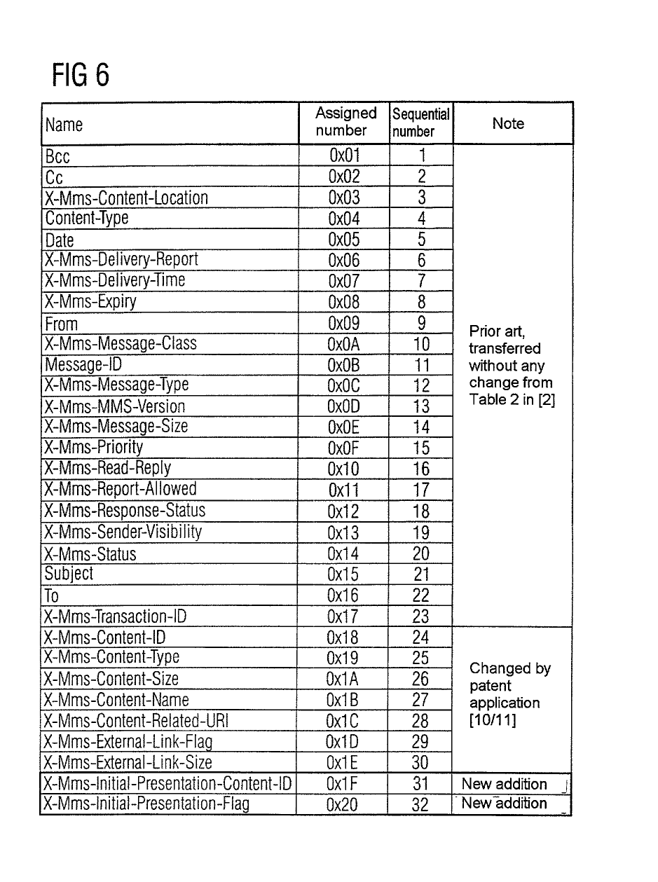

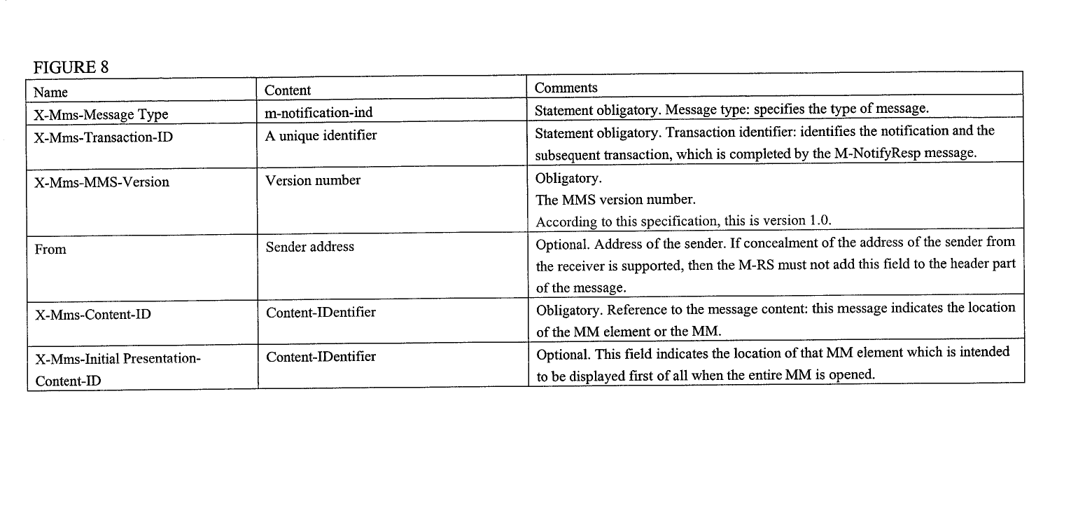

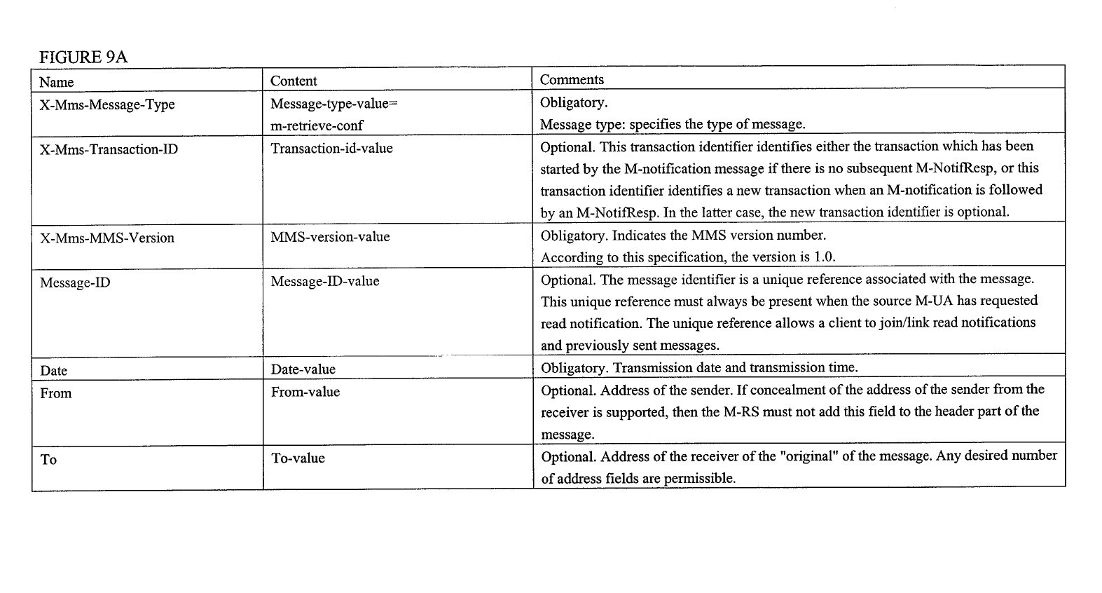

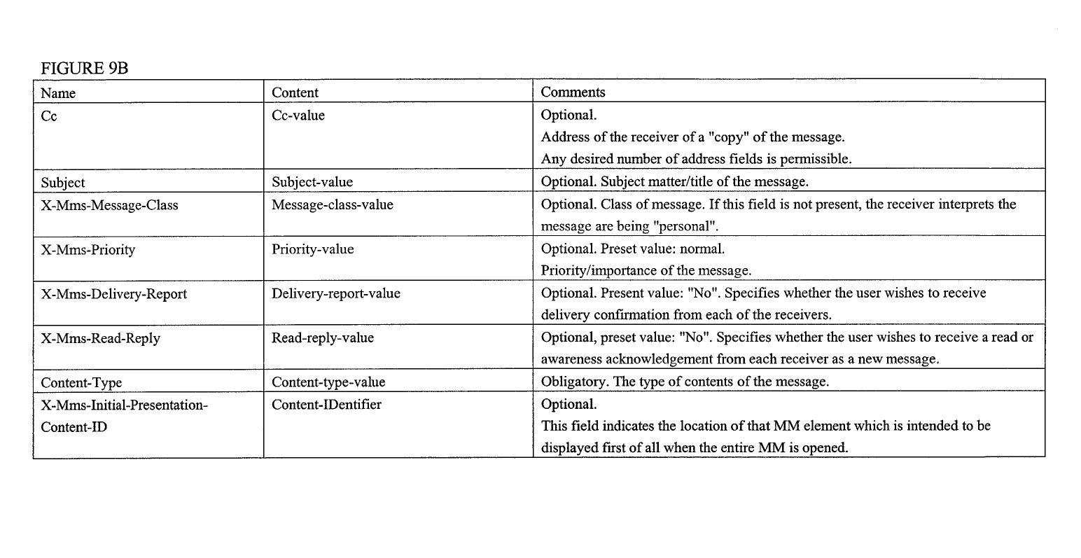

Elements with the same function and methods of operation are in each case provided with the same reference symbols in all the FIGS. 1 to 9.

The exemplary embodiment describes the application of the present invention to a data transmission scheme 1 for the WAP standard, as is used for the transmission of, in particular, picture data and formatted text data using the Universal Mobile Telecommunications Standard, the UMTS standard. The present invention also can, of course, be transferred to other standards. In particular, this includes mixed communications systems, which include not only mobile radio paths but also landline connections or the like.

As has already been described in the introduction, the UMTS standard provides for a so-called Multimedia Message Service MMS to be provided for the transmission of messages, also referred to as Multimedia Messages MMs, in addition to the previous Short Message Service SMS. This allows formatted texts and pictures to be transmitted, with and without audio. The SMS restriction to a message length of 160 characters no longer exists. Audio and video messages can be transmitted, inter alia.

MMS can be implemented using WAP. In this case, the communications system 1 shown in the illustration of FIG. 1 and based on the Wireless Session Protocol Scheme WAP WSP is used for radio transmission of data; for example, Multimedia Messages MMS. This scheme includes a level 2 of a data transmitter, also referred to as an MMS User Agent A M-UA_A. A provider level 3 is also provided, whose network element carries out the service and is referred to in the following text as the MMS Relay M-SR. Finally, a level 4 is provided as a receiver level, which is also referred to as MMS User Agent B M-UA_B.

It is, of course, possible for there to be more than just one provider, by way of example, in level 3. This can be done, for example, by the data transmitter M-UA_A and the chosen receiver M-UA_B being associated with different providers. Furthermore, these different providers also may be connected to one another by third providers as network operators. Here, however, the above simplified representation has been chosen, since the precise level 3 structure is irrelevant to the basic signal sequence.

The illustration in FIG. 1 accordingly shows the so-called transaction flow diagram based on the prior art [2] in which WAP messages are interchanged between only three involved instances, MMS User Agent A M-UA_A, MMS Relay M-SR and MMS User Agent B M-UA_B for transmitting and receiving an MM. An MM User Agent is an application in a subscriber terminal which provides the MMS functionality. The data transmitter level 2 includes at least one subscriber terminal or telecommunications appliance 5, and the receiver level 4 likewise includes a subscriber terminal or telecommunications appliance 6. These telecommunications appliances 5, 6 may, for example, be in the form of conventional mobile telephones or appliances with further input or display functions, such as laptops.

The sequence of individual signals in the communications system 1 as described above will now be explained, as is required to send an MMS from the MMS User Agent A M-UA_A via the MMS Relay M-SR to the MMS User Agent B M-UA_B.

A Multimedia Message MM which is compiled in the telecommunications appliance 5 of the transmitter M-UA_A, or is to be passed on via it, may include one or more elements or data sets; for example, individual pictures, film sequences, texts or the like. The MM is first of all sent to the provider M-SR in level 3 as a request transmission, which is called M-Send. req in the WAP protocol. From there, the received transmission is acknowledged with an acknowledgement M-Sconf to the transmitter M-UA-A in level 2. According to the WAP protocol, this acknowledgement is referred to as M-send. conf.

Following this in time, the provider M-SR sends an information item M-Nind to the receiver M-UA-B in level 4, informing the latter that the provider M-SR has a message for it to download, and this is referred to as M-Notification. ind according to the WAP protocol.

In response to this, the provider M-SR, for example, automatically receives an acknowledged response M-NRind or M-NotifyResp. req in accordance with the WAP Standard from the telecommunications appliance 6 of the receiver M-UA-B returned from level 4 to level 3. When, and only when, a request is made by the receiver with a transmission W-Greq or, in a corresponding manner, WSP GET. req, the provider M-SR passes on the MM with a transmission M-Rconf or M-retrieve. com to the receiver M-UA-B. A message M-Aind or M-Acknowledge. ind acknowledges reception of the MM in level 4. A final message M-Dind or M-Delivery. ind returns a reception confirmation from level 3 to the transmitter M-UA-A in level 2.

So-called header fields are used to manage the transmissions referred to above; that is to say, fields which precede the actual MMS and/or individual elements, and which may contain information about the source, transmission time, file size and further details. According to the present invention, the number of header fields is increased, or their entries are modified, to be precise in order to define a field request and/or a tag for a start indication, via which the MM is intended to be indicated, or played, automatically as a start point and immediately after presetting by the transmitter M-UA-A.

Three basic options relating to this have been proposed above. In case 1 and case 2, a header for the entire MM was modified via one or more field entries. In case 3, a marking is added in the header fields, in a specific element or data set in the data part of the MM.

Of the three options mentioned, the first two have the advantage that a header of the MM contains additional information. In consequence, this information is included not only in the M-Sreq message for transmission of the MM and in the message M-Rconf for dispatch of the MM, but also in the message M-Nind for notifying the receiver that there is an MM awaiting dispatch.

The last-mentioned message M-Nind in this case does not include the data part of the MM. In the third case, this new information above the marked element in the MM is thus not included in the notification, either. For this purpose, a data set according to the third case is distinguished having a smaller amount of data than in the two previous embodiments.

If the elements of the MM in the data part are allocated unique identifiers, for example content IDs, one of the first two options can be implemented. In case 1, an additional header field is inserted in the header of the MM, contained in the content ID of the MM element to be marked. The new header field X-Mms Initial Presentation Content ID as has been proposed is used for this purpose, see FIG. 6.

In case 2, the header of the MM has inserted in it a description of the element which starts with the same identifier content ID and is associated with the element of the MM in the data part of the MM. In this description, the element to be marked in the MM is marked by inserting the new Initial Presentation Flag parameter, as proposed here.

In case 3, the MM element is identified directly in the data part via the header field X-Mms Initial Presentation Flag, see FIG. 3, in order to inform the receiving User Agent that the element is intended to be output or displayed as soon as the MM is opened. However, the receiver does not receive this information until the entire message is downloaded via the M-Rconf message.

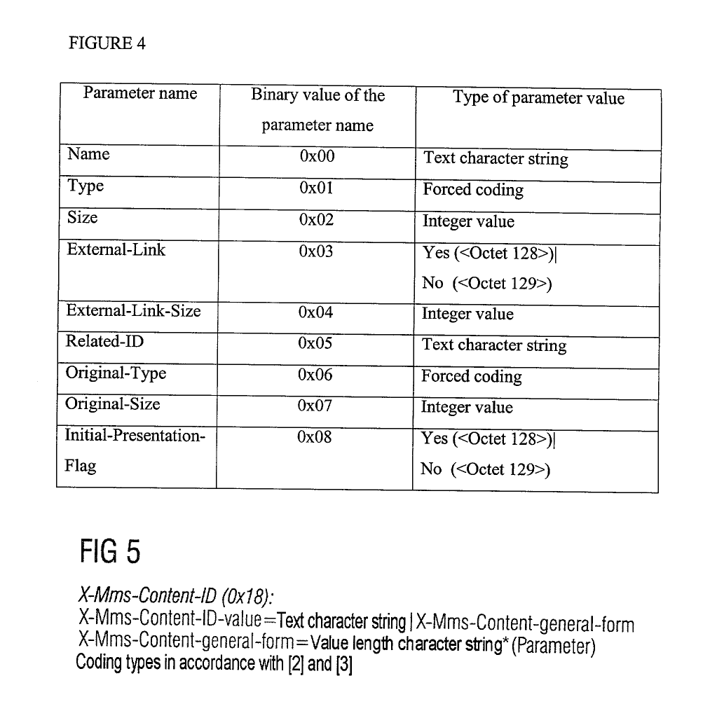

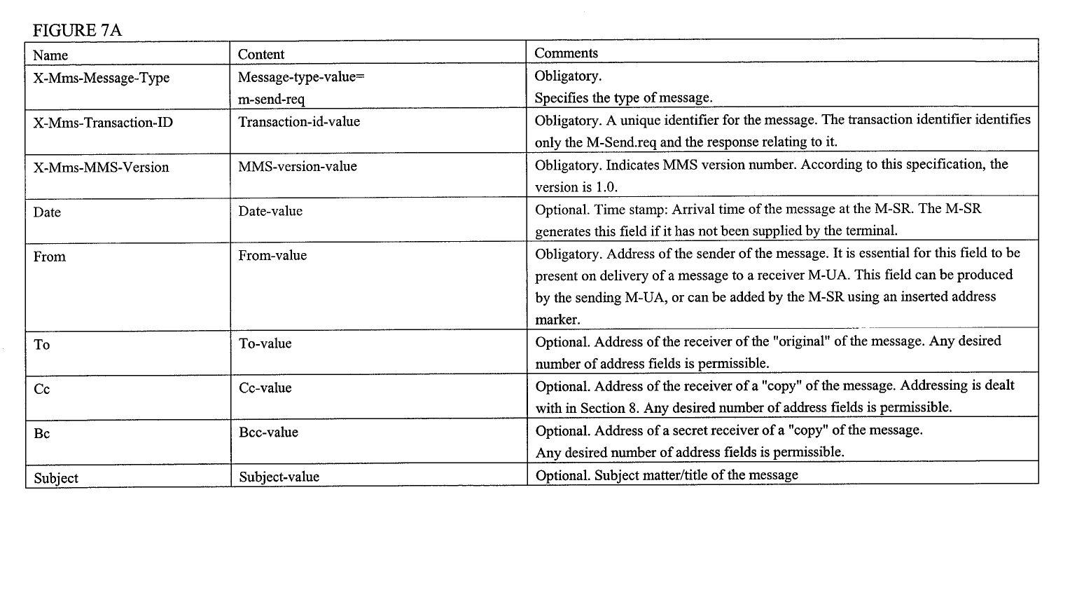

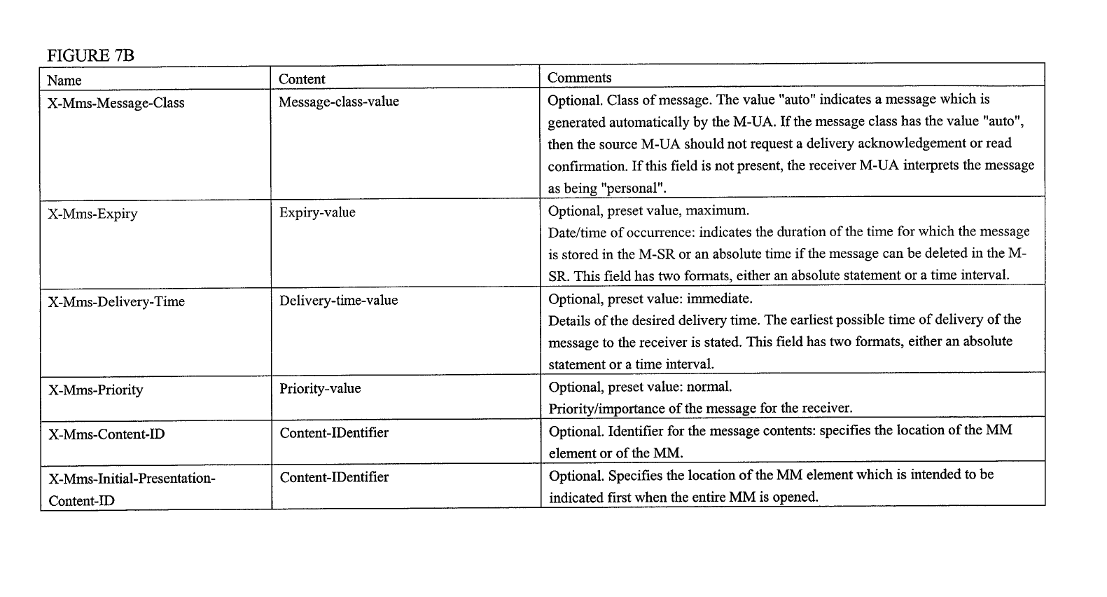

The binary codes for both new header fields X-Mms Initial Presentation Content ID and X-Mms Initial Presentation Flag are shown in FIG. 4, in which case it is also possible to implement only one of the versions. The integration of the header field X-Mms Initial Presentation Flag in the WAP definitions for the messages M-Sreq, M-Nind and M-Rconf is shown in the tables in FIGS. 7 to 9. In combination with the header field X-Mms Content ID, which is new in accordance with the patent application [11], the version which is defined as case 2 is particularly suitable for the desired functionality, is the preferred one of the versions described here, and will be described on the basis of an exemplary embodiment which will be described in detail.

The exemplary embodiment, which is based on the binary codings of the messages interchanged in the MMS as defined by the WAP forum, demonstrates the possibility of identification with the Initial Presentation Flag in the MM header as in version 2. Changes according to the present invention are represented by outline frames, for the sake of clarity. Corresponding annotations according to the WAP standard are mentioned at suitable points, for this purpose.

The following scenario is assumed in this case:

MMS User Agent A sends an MM including a text, an MP3 audio, a JPEG picture, a MPEG-4 video and a SMIL presentation description to an receiver User Agent B. The individual elements are described in detail in the header in accordance with the patent application [11]. In addition, the text element is tagged by the Initial Presentation Flag in the corresponding header field X-Mms Content ID of the MM. The flag is transmitted to the receivers in the messages M-Sreq, M-Nind and M-Rconf. The following messages are transmitted between the units.

MM is sent to the addressee:
M-Sreq (M-UA A → M-SR):
X-Mms-Message-Type: m-send-req
X-Mms-Transaction-ID: TRANSACTION-ID#1
X-Mms-Version: 1.0
Date: Fri, 14 Jul 2000 14:12:19 + 0100
From: UserA@t-online. de
To: UserB@sal. siemens.de
Subject: Holiday greetings from Spiekeroog
X-Mms-Delivery-Report: Yes
X-Mms-Content-ID: <000714. 1412. 1UserA>; Name =
“Holiday greetings. txt”;

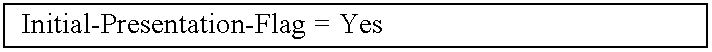

X-Mms-Content-ID: <000714. 1412. 2UserA>; Name =
“Holiday home. jpg”
X-Mms-Content-ID: <000714. 1412. 3UserA>; Name =
“Spiekeroog. smi”;
X-Mms-Content-ID: <000714. 1412. 4UserA>; Name =
“Sound of the sea. mp3”
X-Mms-Content-ID: <000714. 1412. 5UserA>; Name =
“Island train. mpg”
Content-Type: Application/vnd. wap. multipart. related:
Start = <000714. 1412. 3. UserA>
nEntries: 5
HeadersLen: XX
DataLen: XX
Content-Type: text/plain;
X-Mms-Content-ID: <000714. 1412. 1UserA>
Hello UserB,
Many holiday greetings from Spiekeroog. Having a great time.
If you want to get a taste of it, you can find more information on:
http://www.spiekeroog.de
Hope you are having fun at work;-)
Regards
UserA
HeadersLen: XX
DataLen: 1265
Content-Type: image/jpeg
X-Mms-Content-ID: <000714. 1412. 2UserA>
. . .
HeadersLen: XX
DataLen: 588
Content-Type: application/smil,
X-Mms-Content-ID: <000714. 1412. 3UserA>
. . .
HeadersLen: XX
DataLen: 82345
Content-Type: audio/mp3,
X-Mms-Content-ID: <000714. 1412. 4User A>
. . .
HeadersLen: XX
Datalen: 632564
Content-Type: video/mpeg4,
X-Mms-Content-ID: <000714. 1412. 5UserA>
. . .

Header fields in the header of the message are coded in order to describe the MM elements (X-Mms-Content-ID). The field for describing the text element contains the new Initial Presentation Flag.

According to the prior art, the transmit request (WAP: M-Send. req) from the MMS User Agent A is acknowledged by the M-SR with a message M-Sconf (in WAP: M-Send. conf). This message is not modified for the purposes of the present invention, and is therefore not described here.

Provision is made in MMS [1, 2] for an MMS subscriber to be informed about new messages which are waiting for him/her and are ready to be downloaded.

This is done via the receiver notification M-Nind (in WAP: M-Notification. ind). In this example, a notification is sent to the receiver User B.

a) M-Nind to a “To Receiver”;
X-Mms-Message-Type: m-notification-ind
X-Mms-Transaction-ID: TRANSACTION-ID#2
X-Mms-Version: 1.0
From: UserA@t-online. de
X-Mms-Message-Class: Personal
X-Mms-Message-Size: XXX (Attachments + Header)
X-Mms-Expiry: 3600
X-Mms-Content-Location: www. sal. siemens/de/mms-inbox/ABCD. 1234
Subject: Holiday greetings from Spiekeroog
X-Mms-Content-ID: <000714. 1412. 1UserA>; Type =
text/plain; Name = “Holiday greetings. txt”;

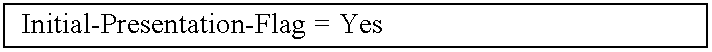

X-Mms-Content-ID: <000714. 1412. 2UserA>; Type =
image/bmp; Name = “Holiday home. jpg”
X-Mms-Content-ID: <000714. 1412. 3UserA>; Type =
application/smil; Name = “Spiekeroog. smi”;
X-Mms-Content-ID: <000714. 1412. 4UserA>; Type =
audio/mp3; Name = “Sound of the sea. mp3”
X-Mms-Content-ID: <000714. 1412. 5UserA>; Type =
video/mpeg4; Name = “Island train. mpg”

In addition to the normal message fields, the Initial Presentation Flag is now transferred from M-Sreq message to the M-Nind message. In addition, the M-SR also generates the information type from the information in the body of the message M-Sreq, and the picture which is contained is converted from the image/jpeg type to the image/bmp type, since the terminal in this example cannot display JPEG pictures.

The description of the text element contains the Initial Presentation Flag. The other elements are coded appropriately in accordance with [2] and the patent applications [10, 11].

According to the prior art, the MM is now downloaded via a command W-Greq. The MM is then sent from the M-SR to the MM-UA A in the message M-Rconf.

The receiver User B now completely downloads the message to his/her terminal. The message M-Rconf is coded as follows:

M-Rconf (M-SR → M-UA B):
X-Mms-Message-Type: m-retrieve-conf
X-Mms-Transaction-ID: TRANSACTION-ID#3
X-Mms-Version: 1. 0
Date: Fri, 14 Jul 2000 14:12:19 + 0100
From: UserA@t-online. de
To: UserB@sal. siemens. de
X-Mms-Message-ID: MESSAGE-ID#1
X-Mms-Delivery-Report: Yes
Subject: Holiday greetings from Spiekeroog
Content-Type: Application/vnd. wap. multipart. related:
Start = <000714. 1412. 3. UserA>
nEntries: 5
HeadersLen: XX
DataLen: XX
Content-Type: text/plain;
X-Mms-Content-ID: <000714. 1412. 1UserA>; Name = “Holiday
greetings. txt”;

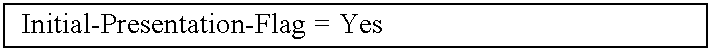

Hello UserB,
Many holiday greetings from Spiekeroog. Having a great time.
If you want to get a taste of it, you can find more information on:
http://www. spiekeroog. de
Hope you are having fun at work;-)
Regards
UserA
HeadersLen: XX
DataLen: 5863
Content-Type: image/bmp
X-Mms-Content-ID: <000714. 1412. 2UserA>; Name =
“Holiday home. bmp”; Original-Type = image/jpeg; Original-Size = 1265
. . .
HeadersLen: XX
DataLen: 588
Content-Type: application/smil,
X-Mms-Content-ID: <000714. 1412. 3UserA>; Name =
“Spiekeroog. smi”
. . .
HeadersLen: XX
DataLen: 82345
Content-Type: audio/mp3,
X-Mms-Content-ID: <000714. 1412. 4User A>; Name =
“Sound of the sea. mp3”
. . .
HeadersLen: XX
Datalen: 632564
Content-Type: video/mpeg4,
X-Mms-Content-ID: <000714. 1412. 5UserA>; Name = “Island
train. mpg”
. . .

The receiver M-UA_B then acknowledges the successful reception of the MM, in accordance with the prior art, using the message M-Aind.

The Initial Presentation Flag is integrated in X-Mms-Content-ID field in the message M-Rconf and is associated directly in the data part with that element of the MM which is intended to be output as soon as the MM is opened. There is thus no need for the receiving M-UA to store the information from the receiver notification M-Nind. The information about which element of the MM should be output as soon as the MM is opened is linked directly to the element in the MM.

The further messages in an MMS implementation are not affected by the present invention, and are thus not described. In summary, various options for causing an element to be displayed immediately and automatically when an MM is opened, by a receiver, by tagging the relevant element, have been described above, together with a number of the respective advantages.

Although the present invention has been described with reference to specific embodiments, those of skill in the art will recognize that changes may be made thereto without departing from the spirit and scope of the invention as set forth in the hereafter appended claims.

Background details relating to WAP, MMS and previous applications can be found in summarized form not only in the documents cited above but also, in particular, in the following references:

[1] 3G TS 23. 140 version 4. 1. 0, Release 4; Third Generation Partnership Project; Technical Specification Group Terminals; Multimedia Messaging Service (MMS); Functional Description; Stage 2

[2] WAP-209-MMS Encapsulation, Release 2000; Wireless Application Protocol; WAP Multimedia Messaging Service; Message Encapsulation; MMS Proposed SCD 1. 0

[3] WAP-203-WSP, Version 4-May-2000; Wireless Application Protocol, Wireless Session Protocol Specification; Chapter 8. 4: “Header Encoding”.

[4] 3G TS 22. 140 v. 4. 0. 1 (July 2000): 3rd Generation Partnership Project; Technical Specification Group Services and System Aspects; Service Aspects; Stage 1 Multimedia Messaging Service.

[6] RFC822: “Standard for the Format of ARPA Internet Text Messages”, Crocker D. , August 1982. URL: ftp://ftp.isi.edu/in-notes/rfc822.txt.

[7] RFC2045: “Multipurpose Internet Mail Extensions (MIME) Part One: Format of Internet Message Bodies”, Freed N., November 1996. URL: ftp://ftp.isi.edu/in-notes/rfc2045.txt. [8] RFC2046: “Multipurpose Internet Mail Extensions (MIME) Part Two: Media Types”, Freed N., November 1996. URL: ftp://ftp.isi.edu/in-notes/rfc2046.txt.

[9] RFC2047: “MIME (Multipurpose Internet Mail Extensions) Part Three: Message Header Extensions for Non-ASCII Text”, Moore K., November 1996. URL: ftp://flp.isi.edu/in-notes/rfc2047.txt.

[10] Trauberg, M. et al. : Verfahren zur detaillierten Benachrichtigung eines Eimpfangers einer Multimedia Message mit Informationen über die einzelnen Bestandteile der Message im Multimedia Messaging Service (MMS) der dritten Mobilfunkgeneration und zum gezielten Herunterladen einzelner Bestandteile einer Message” [Method for detailed notification of a receiver of a multimedia message with information about the individual components of the message in the multimedia messaging service (MMS) for third- generation mobile radio, and for deliberate downloading of individual components of a message], Patent Application with the application number EP 01 101 057. 6.

[11] Trauberg, M. et al.: “Verfahren zur detaillierten Benachrichtigung eines Empfangers einer Multimedia Message im Multimedia Messaging Service (MMS)” [Method for detailed notification of a receiver of a multimedia message in the multimedia messaging service (MMS)], Patent Application with the application number EP 01 107 278.2.

[12] Synchronized Multimedia Integration Language (SMIL 2. 0) Specification; W3C Working Draft Mar. 01, 2001; http://www.w3.org/TR/smil20/

1. A method for transmitting data in a communications systems, the data including at least one of text data and picture data with or without audio, the method comprising the steps of:
assembling a data set to be transmitted from individual elements which are each coded using standards which may be the same or different; and
tagging one element to allow the element to be displayed as soon as the data is opened.

2. A method for transmitting data as claimed in claim 1, the method further comprising the step of preprocessing the data for dispatch, wherein the data has a header for transporting organization information and a body for transporting respective payload information, the information being in the form of a plurality of data packets.

3. A method for transmitting data as claimed in claim 2, the method further comprising the step of transmitting the data as a Multimedia Message in a Multimedia Message Service.

4. A method for transmitting data as claimed in claim 3, wherein the data is transmitted to a WAP-compatible mobile telephone.

5. A method for transmitting data as claimed in claim 4, the method further comprising the step of creating an additional header field for tagging.

6. A method for transmitting data as claimed in claim 5, wherein at least one of a field name and a field value is coded.

7. A method for transmitting data as claimed in claim 6, wherein the header field in WAP is coded via at least one of:
(a) coding of the field name X-Mms Initial Presentation Content ID as 0x1F; and
(b) coding of the field value of X-Mms Initial Presentation Content ID as a text string.

8. A method for transmitting data as claimed in claim 7, wherein information in the header of the Multimedia Message is coded with the header field X-Mms Initial Presentation Content ID, and the element to be annotated is assigned a content ID in a data part of the data to be transmitted.

9. A method for transmitting data as claimed in claim 6, wherein the additional header field in WAP is coded via at least one of:
(a) coding of the field name X-Mms Initial Presentation Flag as 0x20; and
(b) coding of the field value of X-Mms Initial Presentation Flag.

10. A method for transmitting data as claimed in claim 9, wherein an element to be annotated in a data part of the MM is assigned the header field X-Mms Initial Presentation Flag.

11. A method for transmitting data as claimed in claim 10, wherein the element is tagged in a data part of the data to be transmitted.

12. A method for transmitting data as claimed in claim 1, the method further comprising the steps of:
assigning an element to be annotated a content ID in a data part of the Multimedia Message;
inserting a cross-reference to the content ID in the header of the Multimedia Message, via which a description of the element of the Multimedia Message is inserted; and
tagging, within the description, the element of the Multimedia Message with an Initial Presentation Flag parameter.

13. A method for transmitting data as claimed in claim 12, wherein the tag is coded in the data and is sent from a sending Multimedia Message Service User Agent to a Multimedia Message Service Relay for sending the Multimedia Message.

14. A method for transmitting data as claimed in claim 12, wherein the tag is coded in the data and is sent from a Multimedia Message Service Relay to a receiving Multimedia Message Service User Agent in order to notify the receiving User Agent that new data is present.

15. A method for transmitting data as claimed in claim 12, wherein the tag is coded in the data and is sent from a Multimedia Message Service Relay to a receiving Multimedia Message Service User Agent for delivery of the Multimedia Message.

16. A method for transmitting data as claimed in claim 12, wherein a tagged element is transmitted in a preferred manner to a receiving User Agent.

17. A method for transmitting data as claimed in claim 12, wherein a predetermined information item in the data element that is to be opened initially is used as a decision aid to determine whether the tagged element is intended to be transmitted in a preferred manner or on its own to a User Agent.

18. A subscriber terminal for transmission of at least one of transmitting and displaying data, the data including at least one of text data and picture data with or without audio, the terminal comprising:
parts for assembling a data set to be transmitted from individual elements which are each coded using standards which may be the same or different; and
parts for tagging one element to allow the element to be displayed as soon as the data is opened.

19. The subscriber terminal as claimed in claim 18, wherein the subscriber terminal is in a mobile telephone based on a UMTS standard.

20. A computer program product, comprising a computer-legible storage medium on which a program is stored which, upon being loaded into a memory of a computer, allows a data processing unit to preset a tagging for an element in data to be transmitted, within data transmission in a mobile radio network, in order to allow the element to be displayed immediately when the data is opened at a receiver.

21. A computer program product as claimed in claim 20, wherein the computer program product assembles a data set to be transmitted from individual elements which are each coded using standards which may be the same or different, and tags one element to allow the element to be displayed as soon as the data is opened.
